(19) United States
(12) Patent Application Publication
(10) Pub. No.: US 2020/0167838 A1
(43) Pub. Date: May 28, 2020

(54) PLAUSIBILITY-BASED VALIDATION OF PRODUCT COSTING STRUCTURES

(71) Applicant: SAP SE, Walldorf (DE)

(72) Inventor: Vladimir Wasiutinski, Dresden (DE)

(21) Appl. No.: 16/199,820

(22) Filed: Nov. 26, 2018

(51) Int. Cl. G06Q 30/02; G06F 9/451; G06F 17/18

(52) U.S. Cl. CPC G06Q 30/0283; G06F 17/18; G06F 9/451

(57) ABSTRACT

A user interface is presented that allows a user to enter data for a product costing structure. The product costing structure contains data for one or more component items of the product. Based on a database that stores other product costing structures, the data of the product costing structure is validated and one or more informational messages are presented on the user interface. Multiple plausibility checks are realized as separate functions. Each of the separate functions approves the data as being plausible or produces a message indicating an implausibility of the data. The product structure may be a hierarchical structure that consists of items of a product. A plausibility check may be performed on the hierarchical relationship of the items. A plausibility check may be performed to determine if scalar values in the product costing structure are within a plausible range.

### TECHNICAL FIELD

The subject matter disclosed herein generally relates to product costing structures. Specifically, the present disclosure addresses systems and methods to implement plausibility-based validation of product costing structures.

### BACKGROUND

Product costing is a process of estimating costs of fixture products. Product costing may be based on a product structure that includes sub-items of different item types (e.g., materials, activities, and so on). Users enter data into the product structure to determine total costs of a product. A product may have thousands of items. Each item may have master data such as price. Based on the product structure and the master data, the costs of the final product are calculated and production decisions are made.

Users may make typographical errors when entering data or accidentally omit data entirely. Errors in data entry are manually detected and corrected.

### BRIEF DESCRIPTION OF THE DRAWINGS

Some embodiments are illustrated by way of example and not limitation in the figures of the accompanying drawings.

FIG. 1 is a network diagram illustrating a network environment suitable for plausibility-based validation of product costing structures, according to some example embodiments.

FIG. 2 is a block diagram of an application server, according to some example embodiments, suitable for providing plausibility-based validation of product costing structures.

FIGS. 3-4 are a block diagram illustrating a database schema suitable for plausibility-based validation of product costing structures, according to some example embodiments.

FIG. 5 is a flowchart illustrating operations of a method suitable for plausibility-based validation of product costing structures, according to some example embodiments.

FIG. 6 is a flowchart illustrating operations of a method suitable for plausibility-based validation of product costing structures, according to some example embodiments.

FIG. 7 is a flowchart illustrating operations of a method suitable for plausibility-based validation of product costing structures, according to some example embodiments.

FIG. 8 is a flowchart illustrating operations of a method suitable for plausibility-based validation of product costing structures, according to some example embodiments.

FIG. 9 is a flowchart illustrating operations of a method suitable for plausibility-based validation of product costing structures, according to some example embodiments.

FIG. 10 is a user interface diagram of a user interface suitable for plausibility-based validation of product costing structures, according to some example embodiments.

FIG. 11 is a user interface diagram of a user interface suitable for plausibility-based validation of product costing structures, according to some example embodiments.

FIG. 12 is a block diagram illustrating components of a machine, according to some example embodiments.

### DETAILED DESCRIPTION

Example methods and systems are directed to plausibility-based validation of product costing structures. A user interface may be presented that allows a user to enter data for a product structure. The product structure contains data for one or more component items of the product. Based on a database that stores other product costing structures, the data of the product costing structure is validated and one or more informational messages are presented on the user interface.

In some example embodiments, multiple plausibility checks are realized as separate functions. Each of the separate functions approves the data as being plausible or produces a message indicating an implausibility of the data.

Different models and methods may be used for the plausibility checks. For example, the product structure may be a hierarchical structure that consists of items or modules of a product. Each item or module has one or more properties (e.g., a price, a quantity, a process duration, a maturity, and the like). Thus, a plausibility check may be performed on the hierarchical relationship of the items or modules. As another example, the price of each item is a scalar value. Thus, a plausibility check may be performed to determine if the price is within a plausible range. As used herein, a price of an item is the price of a single one of the item and a cost of an item is the total price of the item in a product. For example, in a car product comprising four wheels, each with a price of $250, the cost of the wheels in the car is $1000. Since the cost is derived from the quantity of the wheels and the price of each wheel, the validity of the cost can be determined as a secondary effect of determining the validity of the quantity and the validity of the price. Thus, in some example embodiments, validity of the cost is not determined directly.

Example scalar value checks include: a material price check that detects abnormal material prices and an activity duration check that detects abnormal activity durations. Example structure checks include: a missing item check that detects if an item is missing in a sub-module of the product, when the training data indicates that the item should be present; an unusual frequency check that detects if an item is used an abnormal number of times; a unique item check that detects if item is present that should not be normally present in the product; and a cost share check that detects if a percentage of a type of cost is unusual (e.g., the percentage of material cost or the percentage of processing costs).

The model training and anomaly detection in plausibility checks can be realized by different data analysis and machine learning methods, including: variance test-based anomaly detection, trend-based models, support vector machines (SVMs), and neural networks,

One of the issues in product costing is that a lot of entries and decisions are done manually to involve the experience of the users (e.g., controllers, engineers, and purchasers) into the estimation of cost structures. The users may make typos while entering data, overlook important details, or make wrong entries due to the lack of information. This leads often to errors which may be uncovered too late or not at all because of the large data volumes, which has a dramatic impact on the business. Using the systems and methods described herein, the user entries are validated mostly automatically, reducing the opportunities for error.

By comparison with existing methods of validating product costing structures, in which errors are manually observed or an administrator defines valid ranges for data, the proposed methods increase the probability of detecting an error and reduce the amount of time spent to find the errors. When these effects are considered in aggregate, one or more of the methodologies described herein may obviate a need for certain efforts or resources that otherwise would be involved in validating product costing structures. Computing resources used by one or more machines, databases, or networks may similarly be reduced. Examples of such computing resources include processor cycles, network traffic, memory usage, data storage capacity, power consumption, and cooling capacity.

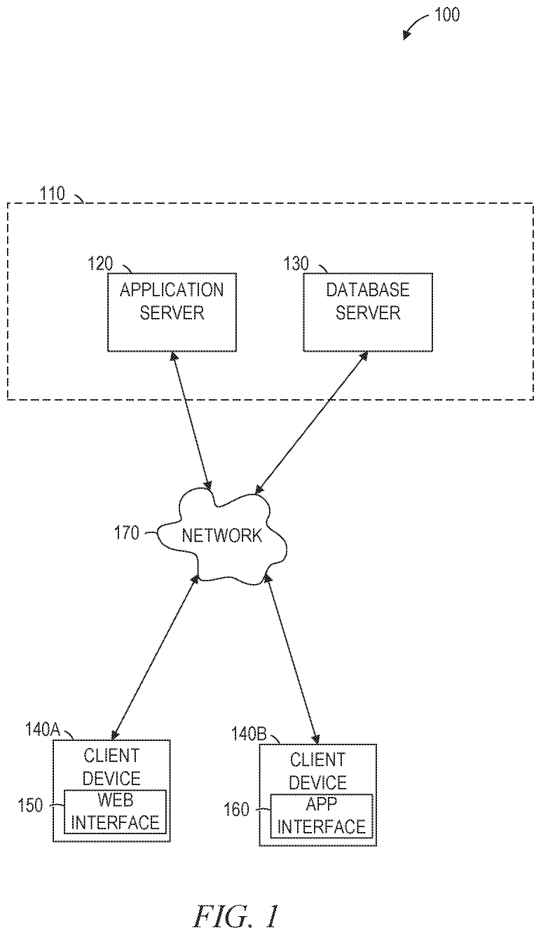

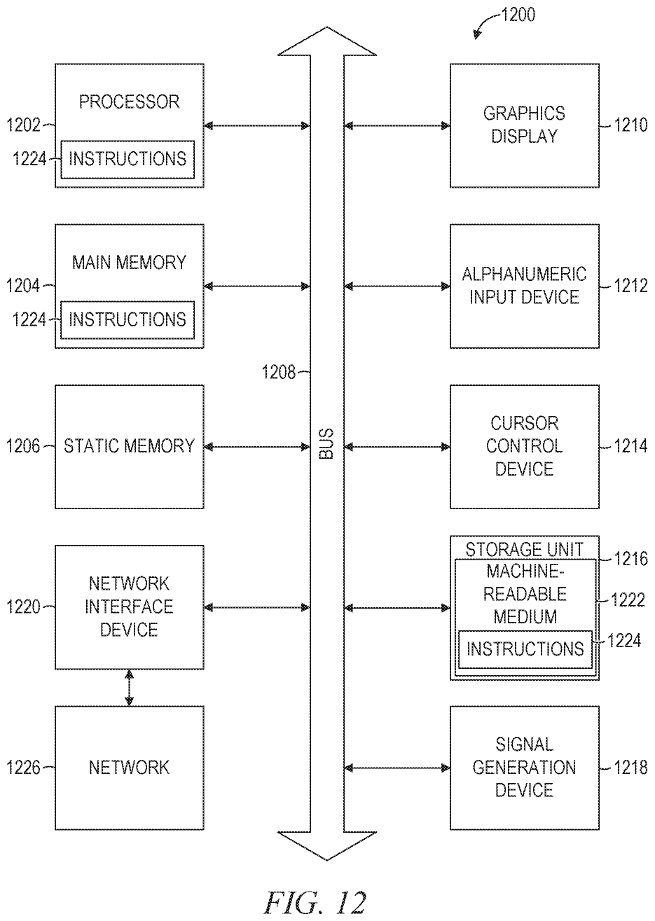

FIG. 1 is a network diagram illustrating a network environment 100 suitable for plausibility-based validation of product costing structures, according to some example embodiments. The network environment 100 includes a network-based application 110, client devices 140A and 140B, and a network 170. The network-based application 110 is provided by an application server 120 in communication with a database server 130. The application server 120 provides an application to the client devices 140A and 140B via a web interface 150 or an application interface 160. The application server 120, the database server 130, and the client devices 140A and 140B may each be implemented in a computer system, in whole or in part, as described below with respect to FIG. 12. The client devices 140A and 140B may be referred to collectively as client devices 140 or generically as a client device 140.

The application server 120 provides a product costing application to the client devices 140. Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 12. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 120, database server 130, and the client devices 140A-140B may be connected by the network 170. The network 170 may be any network that enables communication between or among machines, databases, and devices. Accordingly, the network 170 may be a wired network, a wireless network (e.g., a mobile or cellular network), or any suitable combination thereof. The network 170 may include one or more portions that constitute a private network, a public network (e.g., the Internet), or any suitable combination thereof.

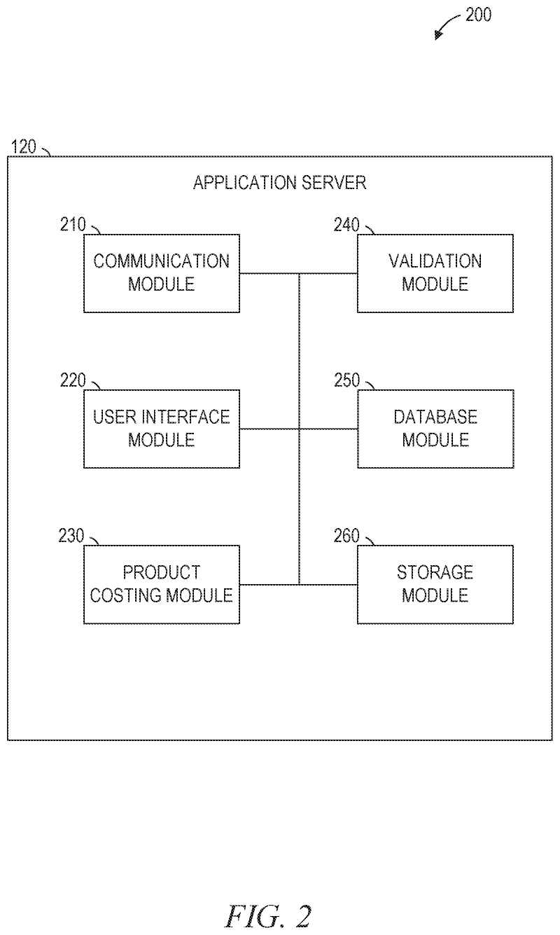

FIG. 2 is a block diagram 200 illustrating components of the application server 120, according to some example embodiments. The application server 120 is shown as including a communication module 210, a user interface module 220, a product costing module 230, a validation module 240, a database module 250, and a storage module 260, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 receives data sent to the application server 120 and transmits data from the application server 120. For example, the communication module 210 may receive, from the client device 140A, data for a product costing structure. The communication module 210 provides the data to the product costing module 230. The product costing module 230 stores the data in a database via the database module 250 and the storage module 260. The communication module 210 may transmit a user interface from the user interface module 220 to the client device 140A that includes data for the updated product costing structure. Communications sent and received by the communication module 210 may be intermediated by the network 170.

The user interface module 220 causes presentation of a user interface for the application server 120 on a display associated with the client device 140A or 140B. The user interface allows a user to view an existing product costing structure, to modify a product costing structure, to create a new product costing structure, to invoke plausibility-based validation of a product costing structure, to view informational messages resulting from plausibility-based validation of the product costing structure, or any suitable combination thereof.

The product costing module 230 receives, via the user interface module 220, data for a product costing structure and stores the data, via the database module 250, in the storage module 260. The validation module 240 performs plausibility-based validation of a product costing structure based on the product costing structure and other product costing structures stored in the database.

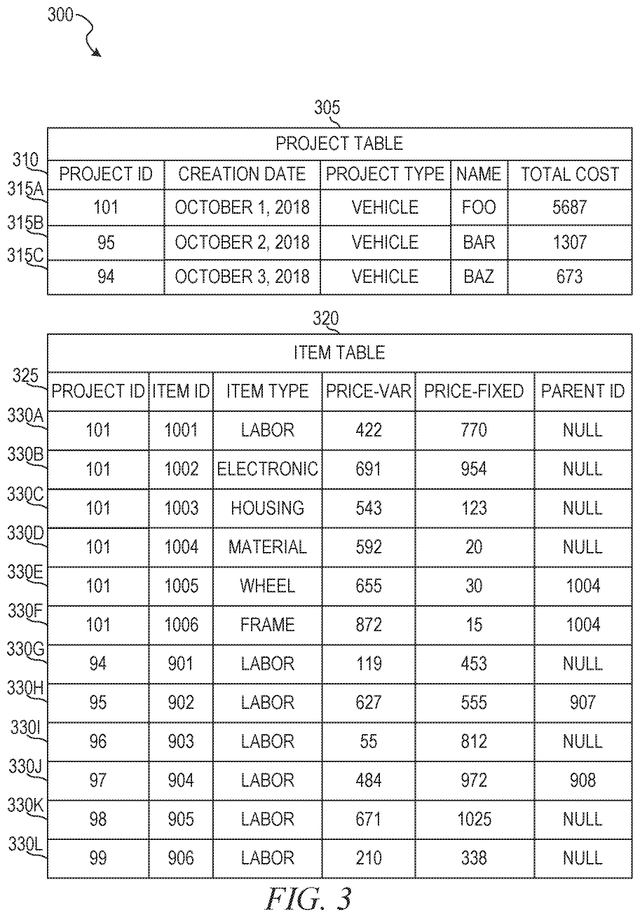

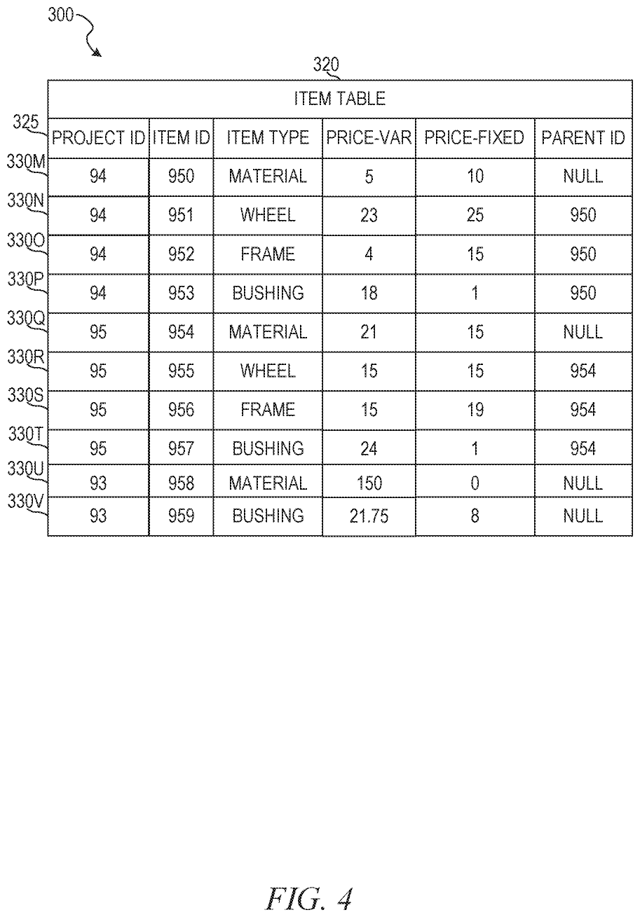

FIGS. 3-4 are a block diagram illustrating a database schema 300 suitable for implementing plausibility-based validation of product costing structures, according to some example embodiments. The database schema 300 includes a project table 305 and an item table 320. The project table 305 has rows 315A, 315B, and 315C of a format 310. Each row of the project table 305 stores data for a product costing structure comprising items. The item table 320 has rows 330A, 330B, 330C, 330D, 330E, 330F, 330G, 330H, 330I, 330J, 330K, and 330L in FIG. 3 and rows 330M, 330N, 330O, 330P, 330Q, 330R, 330S, 330T, 330U, and 330V in FIG. 4. The rows 330A-330V are in a format 325. Each row of the item table 320 stores data for an item in a project costing structure.

The format 310 of the project table 305 includes a project identifier field, a creation date field, a project type field, a name field, and a total cost field. The project identifier field stores a unique identifier for the product costing structure of each row. The creation date field stores a date on which the product costing structure was created. The project type field indicates the type of the product being costed. The name field stores a human-readable name for the project that can be used in a product costing user interface. The total cost field stores the total cost of all items in the product costing structure of the project.

The format 325 of the item table 320 includes a project identifier field, a component identifier field, an item type field, a variable price field, a fixed price field, and a parent identifier field. The item identifier is a unique identifier for each item in a project. The project identifier field stores the project identifier of a row in the project table 305 and indicates which project the item is for. Multiple rows in the item table 320 having the same project identifier contain information for the same project. The item type field indicates the type of the item. The fixed price field indicates a fixed portion of the price of the item. The variable price field indicates a variable portion of the price of the item. The parent identifier field identifies a parent item if the item is not at the top level of the product costing structure. In some example embodiments, the total cost for a quantity of an item is the fixed price of the item plus the variable price of the item multiplied by the quantity of the item. Thus, the cost for a single item, in these example embodiments, is the fixed price plus the variable price.

Thus, each of the rows 330A-330F is for an item in the project 101. The rows 330G-330L are for items of the item type “labor” in projects other than the project 101. The rows 330A-330D, with NULL parent identifiers, are for top-level items of the project 101 while the rows 330E and 330F are component items within the item 1004, of type “material.” The rows 330M-330U are for “material” items and their sub-components in other projects. Further, the rows 330U-330V are for items in the project 93.

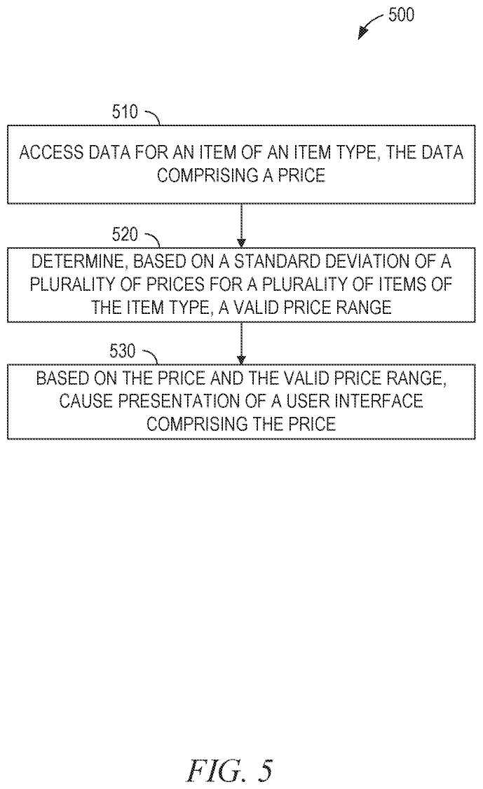

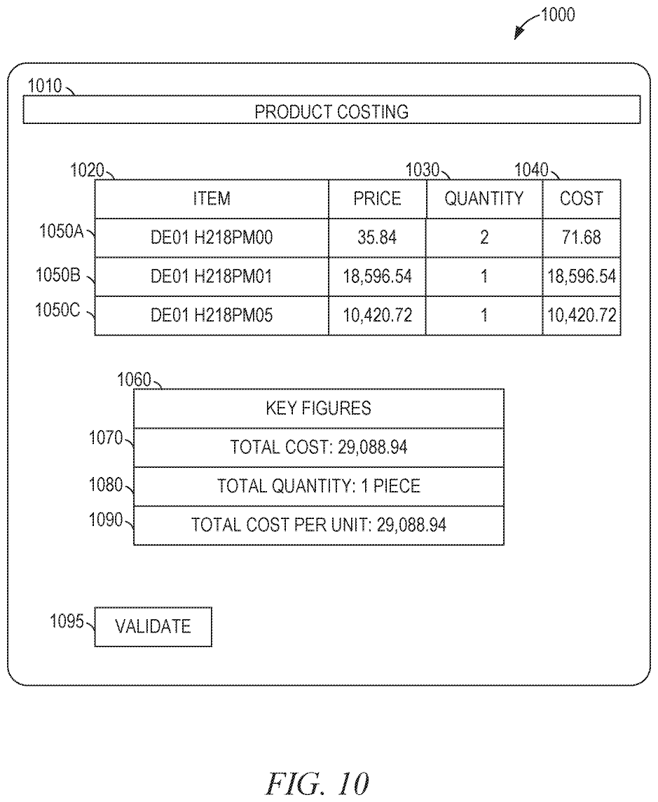

FIG. 5 is a flowchart illustrating operations of a method 500 suitable for plausibility-based validation of product costing structures, according to some example embodiments. The method 500 includes operations 510, 520, and 530. By way of example and not limitation, the method 500 is described as being performed by the devices, modules, and databases of FIGS. 1-4. The method 500 may be performed by the application server 120 in response to receiving a product costing data structure from the client device 140A. For example, the user interface 1000 of FIG. 10, described below, may be displayed on a display device of the client device 140A and data entered into the user interface 900 may be transmitted from the client device 140A to the application server 120 via the network 170.

In operation 510, the validation module 240 accesses data for an item of an item type, the data comprising a price. For example, the fixed price 770 of the item 1001 of the row 330A may be accessed from a database. The item 1001 has an item type of “labor.”

In operation 520, the validation module 240 determines, based on a standard deviation of a plurality of prices for a plurality of items of the item type, a valid price range. For example, data for the items 901-906, each with item type “labor,” may be accessed from the rows 330G-330L of the item table 320. The mean fixed price for the items 901-906 is 692.5 and the standard deviation is 284.6.

In operation 530, based on the price and the valid price range, the validation module 240 causes presentation, via the user interface module 220, of a user interface comprising the price. For example, since the fixed price 770 is within one standard deviation of the mean 692.5, the user interface may indicate the price along with an indication that the price is plausible. Had the difference between the price and the mean been greater than a predetermined multiple of the standard deviation (e.g., one standard deviation, one and a half standard deviations, or two standard deviations) the indication would be that the price is not plausible. Example indications include presenting the price in red for implausible and green for plausible, presenting a first icon for plausible (e.g., a green check mark) and a second icon for implausible (e.g., a red stop sign), presenting an information text message (e.g., “The mean fixed labor price is 692.5 with a standard deviation of 284.6. The fixed labor price for this project of 770 is plausible.”), or any suitable combination thereof. Though this example is described with respect to fixed prices, the method 500 may also be used to determine the plausibility of variable prices or any other scalar value (e.g., the quantity of an item included in a product).

In some example embodiments, the item table 320 includes an additional column that indicates the quantity of the item being used in the project. The cost of the item may be determined based on the quantity, the variable price, and the fixed price. The method 500 may be performed using the cost of the item and a valid cost range instead of the price of the item and a valid price range as described above.

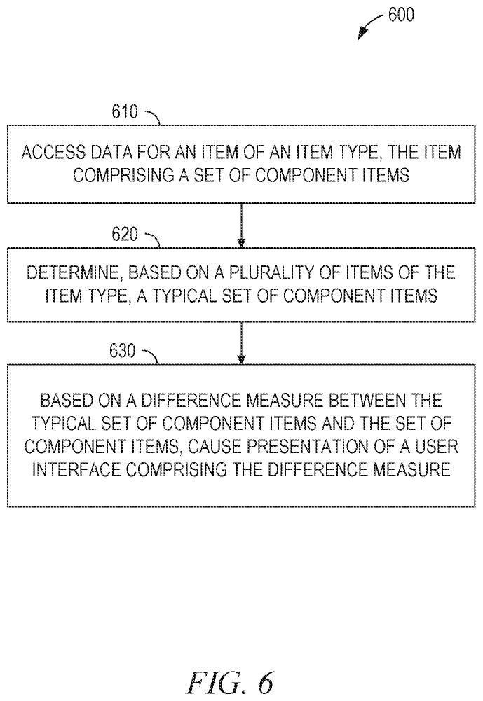

FIG. 6 is a flowchart illustrating operations of a method 600 suitable for plausibility-based validation of product costing structures, according to some example embodiments. The method 600 includes operations 610, 620, and 630. By way of example and not limitation, the method 600 is described as being performed by the devices, modules, and databases of FIGS. 1-4. The method 600 may be performed in addition to or instead of the method 500 when validating a product costing data structure.

In operation 610, the validation module 240 accesses data for an item of an item type, the item comprising a set of component items. For example, the data of rows 330D, 330E, and 330F may be accessed, wherein the items 1005 and 1006 are component items of the item 1004.

In operation 620, the validation module 240 determines, based on a plurality of items of the item type, a typical set of component items. For example, the data of rows 330M-330T may be accessed, wherein the “material” items of projects 94 and 95 comprise “wheel,” “frame,” and “bushing” component items. Thus, the validation module 240 determines that the typical set of component items comprises all three of these types of component items. If the plurality of items of the item type have differing components, the most popular combination of component items may be selected as the typical set.

In operation 630, based on a difference between the typical set of component items and the set of component items, the validation module 240 causes presentation of a user interface comprising the difference measure. For example, since the typical set of component items includes three component items and the set of component items for the item 1004 includes only two component items, an informational message could be presented on the user interface indicating that the present item has one fewer component item than is typical. As another example, since the typical set of component items includes a “bushing” item and the set of component items for the item 1004 does not, an informational message indicating that a “bushing” item should be added may be presented.

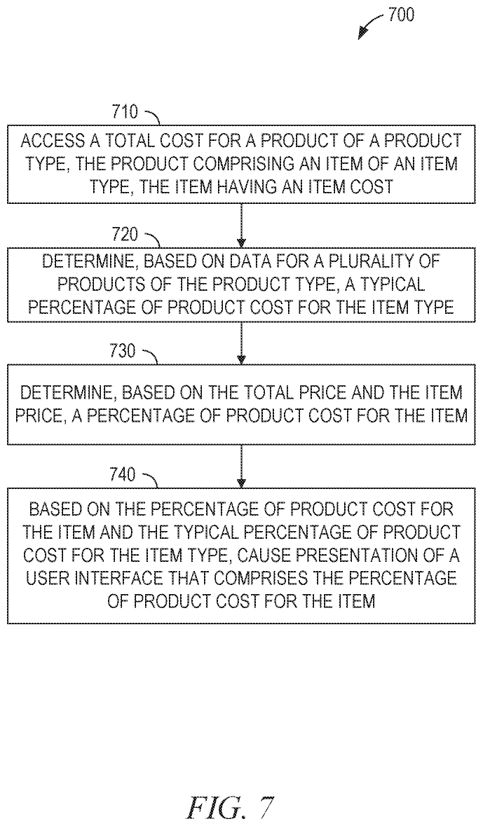

FIG. 7 is a flowchart illustrating operations of a method 700 suitable for plausibility-based validation of product costing structures, according to some example embodiments. The method 700 includes operations 710, 720, 730, and 740. By way of example and not limitation, the method 700 is described as being performed by the devices, modules, and databases of FIGS. 1-4.

In operation 710, the validation module 240 accesses a total price for a product of a product type, the product comprising an item of an item type, the item having an item cost. For example, the row 315A of the project table 305 (FIG. 3) may be accessed to identify a project for a product of the product type “vehicle.” The product comprises the items of the rows 330A-330F of the item table 320, each of which has an item type indicated in the item type field, a fixed price indicated in the fixed price field, and a variable price indicated in the variable price field. The cost of the item is determined based on the quantity of the item, the fixed price, and the variable price (e.g., as fixed price plus quantity times variable price). For the purposes of this example, the quantity of each item will be assumed to be one. The total cost for the product is the sum of the costs of the items that make up the product: 5,687. One of the items of the product is item 1001 of type “labor” and with item cost 1,192.

In operation 720, the validation module 240 determines, based on data for a plurality of products of the product type, a typical percentage of product cost for the item type. For example, the rows 315B and 315C of the project table 305 are also for “vehicle” products with project identifiers 95 and 94, respectively. Item data for the project 95 is found in the rows 330H and 330Q-330T; item data for the project 94 is found in the rows 330G and 330M-330P. The total cost of the product 95 is 1,307; the cost for items of type “labor” is 1,182; thus, the percentage of the product cost for items of type “labor” is 90.4%. Performing a similar calculation for the product 94 reveals that the percentage cost for items of type “labor” is 85.0%. The mean value may be used as the typical percentage. Thus, in some example embodiments, 87.7% is found as the typical percentage of product cost for “labor” items in “vehicle” products.

In operation 730, the validation module 240 determines, based on the total price and the item price, a percentage of product cost for the item. For the project 101, the cost of the item 1001 is 21.0% of the product cost.

In operation 740, based on the percentage of product cost for the item and the typical percentage of product cost for the item type, the validation module 240 causes presentation of a user interface that comprises the percentage of product cost for the item. For example, the difference between the percentage of product cost for the item (21.0%) and the typical percentage of product cost for the item type (87.7%) may be compared to a predetermined threshold (e.g., the variance of the product cost for “labor” items in “vehicle” products) and, if the difference exceeds the threshold, an informational message may be presented in a user interface. The informational message may indicate the percentage of product cost for the item, the typical percentage of product cost for the item type, the predetermined threshold, the difference between the percentage of product cost for the item and the typical percentage of product cost for the item type, or any suitable combination thereof.

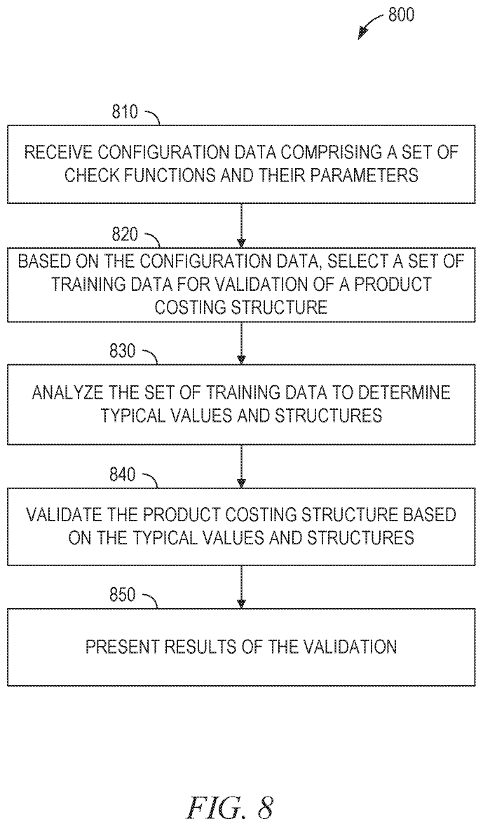

FIG. 8 is a flowchart illustrating operations of a method suitable for plausibility-based validation of product costing structures, according to some example embodiments. The method 800 includes operations 810, 820, 830, 840, and 850. By way of example and not limitation, the method 800 is described as being performed by the devices, modules, and databases of FIGS. 1-4.

In operation 810, the validation module 240 receives configuration data comprising a set of check functions and their parameters. For example, a graphical user interface may be presented to an administrator who identifies the checks to be used (e.g., price range checks, quantity range checks, percentage of cost checks, or any suitable combination thereof). The graphical user interface may further allow the administrator to provide the thresholds for anomaly detection, allowing for adjustment of the sensitivity of the checks. For example, when lower thresholds have been set, the users will receive more validation messages. With higher thresholds, the users will receive only the most significant ones.

In operation 820, the validation module 240, based on the configuration data, selects a set of training data for validation of a product costing structure. The configuration data further includes rules for selection of training data. The rules may specify that training data will be selected from similar products, wherein similarity is determined based on the similar product being within the same project as the product being validated, being at the same production site as the product being validated, or any suitable combination thereof. Additionally or alternatively, the rules may specify that the training data will be selected from recent products (e.g., within the last month, six months, or one year) or from products created within a defined time period. Applying the rules in operation 820, the set of training data is selected.

The validation module 240, in operation 830, analyzes the set of training data to determine typical values and structures. The historical data of the selected similar products are analyzed to automatically extract the typical values and (sub-) structures for different aspects of the costing structures, as well as typical variations of them. The training phase is not necessary for hard-coded checks.

Hard-coded checks are defined entirely in operation 810 and do not require training. Examples of such checks are if a mandatory attribute was not set or has a null value, if an item was not changed for at least a predetermined period of time (e.g., 90 days), if an item does not have a required uncertainty grade, and if a material or activity does not exist in master data or historical calculations.

In contrast to the hard-coded checks, the plausibility checks are learned from the data in the training phase. The plausibility checks include scalar value checks and structure checks.

The scalar value checks prove if scalar values like prices or duration of manufacturing processes significantly deviate from the typical values. Examples of such checks are: material prices checks that detect abnormal material prices, duration checks that detect the abnormal durations of product activities or business processes, and cost share checks that detect unusual proportions of shares of different cost types in the whole calculation or its parts. Due to different product designs, the percentage of different types of costs e.g., material costs or processing costs) may be unacceptable. This will indicate general structural problems within the product.

In operation 840, the validation module 240 validates the product costing structure based on the typical values and structures. During this phase, the potential errors are detected as anomalies.

The validation module 240, via the user interface module 220, presents results of the validation (operation 850). Subsequently, the feedback from the user can be incorporated into trained model (e.g., by taking notice of the false positives or missed errors, as indicated by the user, for adjusting the models).

Generating the user interface may include calculating indicators that help users understand and evaluate the detected anomalies. One example indicator is the cost impact, which shows the potential impact of the anomalies on the total cost of the whole product. This indicator may help users decide which messages should be considered first.

Operations 820 and 830 are validation-check-specific and can be run in parallel. Further, the training can be done at runtime together with the validation as well as periodically in a separate step based on the selected mode. The choice of one of these implementation variants depends on the amount of data, performance of algorithms, database optimization, or any suitable combination thereof.

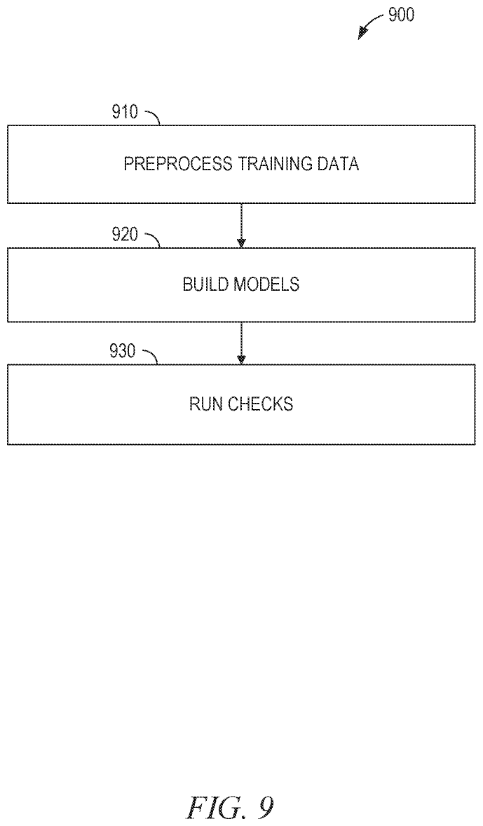

FIG. 9 is a flowchart illustrating operations of a method 900 suitable for plausibility-based validation of product costing structures, according to some example embodiments. The method 900 includes operations 910, 920, and 930. By way of example and not limitation, the method 900 is described as being performed by the devices, modules, and databases of FIGS. 1-4.

In operation 910, the validation module 240 preprocesses training data. For example, in operation 820 of the method 800, training data is selected based on user-provided criteria. The selected training data is pre-processed by applying rules. For example, training data comprising null values or missing attributes may be excluded. The training data may also be normalized. For example, if the price of an item in one product costing structure is given in dollars per kilogram and the price of the item in another product costing structure is given in dollars per hundred. grams, the price of the item is normalized (e.g., by multiplying the price by 10 so that the price is in dollars per kilogram) so that both product costing structures use the same units for the price, allowing them to be compared. As another example, the price of an item in one product costing structure may be given in dollars per kilogram and the price of the same item in another product structure may be given in dollars per pound. Accordingly, the price is normalized (e.g., by multiplying the price by 2.2 so that the price is in dollars per kilogram) so that both product costing structures use the same units for the price.

In operation 920, the validation module 240 builds models of typical product costing structures. Models of normal scalar values and product structures are built in this operation. Examples of models for scalar values include trend-based models, support vector machines (SVM) for non linear models, and neural networks.

The detrended scalar values xᵢ are extracted by determining the residue values from the models

rᵢ=\dot{i}ᵢ−\hat{x}ᵢ,

where the dot indicates original values and the hat indicates estimated values from the previous model building step. If no specific models have been configured, then the residue values are used: rᵢ=\dot{x}ᵢ−x̅ᵢ, where the line indicates the mean value of the examples in the training data.

The validation module 240 calculates model parameters of the items. For each item set (e.g., the set of prices xᵢⱼ for material j), the following characteristics are calculated:
mean x̅ⱼ,
median med(xⱼ),
estimated standard deviation sⱼ,
set of distinct values and their count,
estimated non-biased average coefficient of variation ĉᵥ over all item sets. This coefficient indicates how much the values vary in general and can be estimated as

$${\hat{c}}_{v} = ( 1 + \frac{1}{4 n} ) \cdot \frac{s}{\overline{x}} ,$$

where n is the number of samples. If the number of samples is not sufficient to estimate ĉᵥ, then the default value (typically 0.1-0.3) can be used.

The validation module 240 enriches the model by exploiting the similarity between items and enriching the statistics for the items that have only a few samples and thus have low confidence in the results. For these items, the statistical characteristics are taken from similar items with higher confidence in the statistical characteristics. The pseudocode below provides an example of determining the estimated variance sₜⱼ for the different materials j:

For each material mⱼ:

```
If (contidence(mⱼ)) > t_{c} || [symbol]  > c̅ᵥ̅)
  sₜⱼ = [symbol]  · tₛ
else
  sₜⱼ = c̅ᵥ̅ · ts
```

In the example above, the confidence function provides the degree of confidence in the estimate of the scalar value for the material mⱼ. In some example embodiments, the degree of confidence is the number of training samples used to generate the estimate. If the confidence exceeds a predetermined threshold (e.g., five training samples), the estimated variance is based on the coefficient of variation for the material mⱼ. If the confidence does not exceed the predetermined threshold, the estimated variance is based on the larger of the coefficient of variation for the material mⱼ and the average coefficient of variance for a group of materials (e.g., all available materials). In either case, the coefficient of variance is multiplied by a predetermined factor tₛ (e.g., a predetermined factor in the range of 0.3-3.0). The larger the factor tₛ, the larger the range of values that will not generate an error message. Thus, a user or administrator may configure the system by changing the value of tₛ to increase or decrease the sensitivity of the system to variations between the product costing structure being analyzed and the product costing structures in the training set.

For structure checks, the validation module 240 determines typical product structures by identifying a training set of unique items of the item type and building a vocabulary of parent-child pairs reflecting the parent-child relationships within the items in the training set. The most frequent child items are selected by comparing the number of unique appearances of a child item with a threshold number, wherein the threshold number is a percentage of the size of the training set (e.g., 30%, 60%, or 90%). The most frequent parent-child pairs are selected in the same way, for the determined most frequent child items. Based on the most frequent parent-child pairs, the median number of each represented child under each corresponding parent is determined. The variance of this value is also determined. Thus, for frequently-appearing parent-child relationships, a typical number of the children for each parent is identified, as well as a variance. For example, a product of type vehicle may typically have four wheels, but a non-zero variance indicates that some vehicles have more or fewer wheels. By analyzing all parent-child pairs in the product structures, relationships between multiple levels of subcomponents are automatically considered. For example, a product of type tractor-trailer may comprise a vehicle and a trailer, each of which has wheels as children.

In operation 930, the validation module 240 runs checks. For scalar values, an anomaly is detected if |rᵢⱼ|≥sₜⱼ. In other words, if the magnitude of the difference between the actual value in the product costing structure and the expected value exceeds the determined threshold, an anomaly is detected.

Multiple types of structure checks may be run. A missing item check detects if an item is missing in a sub-module of a product, wherein the item is typically present in similar sub-modules of the training set. An unusual frequency check detects if an item is present an abnormal number of times. For example, the magnitude of the difference between the number of the item present in the product costing structure and the typical number may be compared to the variance of the number of the item in the product costing structures of the training set. If the magnitude of the difference exceeds the variance, the frequency of the item is abnormal. A unique item check detects that an item in the product costing structure was not present in any of the product costing structures of the training set.

FIG. 10 is a user interface diagram of a user interface 1000 suitable for plausibility-based validation of product costing structures, according to some example embodiments. The user interface 1000 includes the title 1010, the column headers 1020, 1030, 1040, and 1060, the rows 1050A, 1050B, and 1050C, informational messages 1070, 1080, and 1090, and a button 1095. The title 1010 indicates that the user interface 1000 is for product costing. The user interface 1000 may be presented on a display of the client device 140A or 140B in response to data received from the application server 120 via the network 170.

The column headers 1020, 1030, and 1040 indicate that the rows 1050A-1050C each contain a name of an item, a quantity of the item in a product, and a cost of the item. The column header 1060 indicates that the informational messages 1070-1090 include key figures for the product such as the total cost (informational message 1070), the total quantity of the product created for the total cost (informational message 1080), and the total cost per unit of the product (informational message 1090).

The item fields of the rows 1050A-1050C may be operable to change the item for the row. For example, the web interface 150 may detect that a user clicks on the name of an item and, in response, text input for the name of the item is received. Alternatively, a drop-down list of available items may be presented or another user interface with more information about the available items may be presented. Additional items may be added to the product costing structure (e.g., by adding an additional row after the row 1050C) in response to receiving a user command. For example, selecting the row 1050C and pressing the Enter key may cause the addition of another row. In some example embodiments, an additional blank row is added each time the last blank row is filled in.

The button 1095 is operable to cause one or more of the methods 500, 600, and 700 to be performed on the displayed product costing structure. As a result, the user interface 1000 may be displayed.

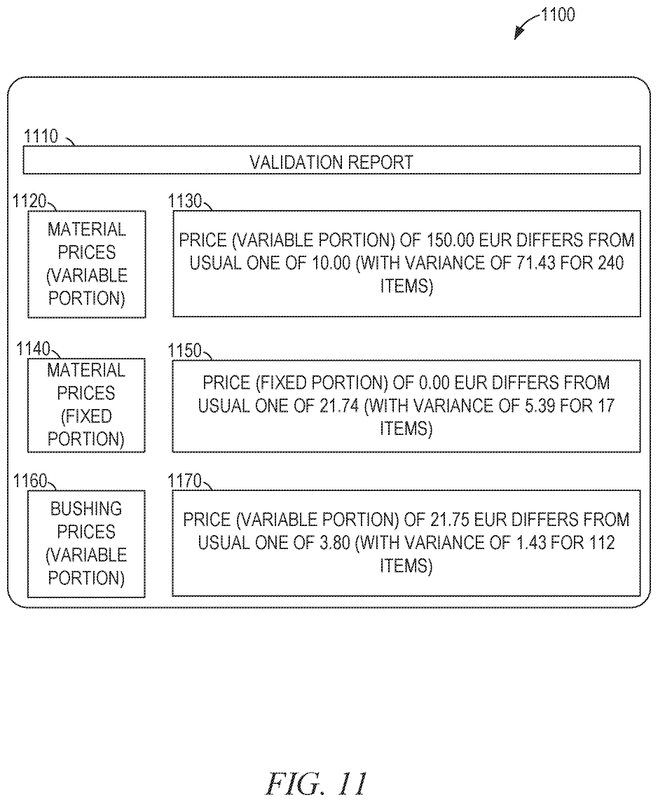

FIG. 11 is a user interface diagram of a user interface 1100 suitable for plausibility-based validation of product costing structures, according to some example embodiments. The user interface 1100 includes the title 1110, the row headers 1120, 1140, and 1160, and informational messages 1130, 1150, and 1170. The title 1110 indicates that the user interface 1100 is for a validation report. The user interface 1100 may be presented in response to operation of the button 1095 (FIG. 10).

The row header 1120 indicates that the informational message 1130 pertains to a variable portion of material prices (e.g., the variable portion of the price of the item 958 of the row 330U in FIG. 3). The informational message 1130 indicates that the variable portion of the material price for the product is 150 Euros, that the usual price is 10 Euros, that the variance in the price is 71.43, and that 240 items were used to determine the usual price and the variance.

The row header 1140 indicates that the informational message 1150 pertains to a fixed portion of material prices (e.g., the fixed portion of the price of the item 958 of the row 330U). The informational message 1150 indicates that the fixed portion of the material price for the product is 0 Euros, that the usual price is 21.74 Euros, that the variance in the price is 5.39, and that 17 items were used to determine the usual price and the variance.

The row header 1160 indicates that the informational message 1170 pertains to a variable portion of bushing prices (e.g., the variable portion of the price of the item 959 of the row 330V). The informational message 1170 indicates that the variable portion of the material price for the product is 21.75 Euros, that the usual price is 3.80 Euros, that the variance in the price is 1.43, and that 112 items were used to determine the usual price and the variance.

Each informational message may be operable to perform an action related to the item to which the informational message pertains. For example, selecting the informational message 1130 may cause the user interface 1000 (of FIG. 10) to be presented with the corresponding item highlighted. As another example, selecting the informational message 1150 may cause the price (fixed portion) of the corresponding item to be changed to the typical value indicated in the informational message 1150. As a third example, selecting the informational message 1170 may confirm that the item data is correct and no correction is needed. In some example embodiments, multiple options are presented via a menu (e.g., a right-click or long touch menu) and the user selects the desired option after causing presentation of the menu.

The informational messages may include further information, such as total impact (the total cost impact on the product due to the anomaly described in. the informational message), item type, severity (e.g., minor or severe), or certainty (e.g., low, medium, or high, based on the size of the training set). Further, the user may filter or sort the messages according to different criteria (e.g., total impact, item type, severity, or any suitable combination thereof).

### EXAMPLES

### Example 1

A method comprising:

receiving, from a client device and via a network, a first set of items for a product, the first set of items comprising a first item of a first item type and a second item of a second item type, the second item comprising a second set of component items;
accessing, from a database, first data for the first item, the first data comprising a first price;
accessing, from the database, a plurality of prices for a first plurality of items of the first item type;
determining, by one or more hardware processors and based on a standard deviation of the plurality of prices for the first plurality of items of the first item type, a valid price range;
accessing, from the database, data identifying a set of component items for each item of a second plurality of items of the second item type;
determining, by the one or more hardware processors and based on the data, a typical set of component items;
determining, by the one or more hardware processors, a difference measure between the typical set of component items and the second set of component items; and
causing the client device to present a user interface comprising the first price and the difference measure.

### Example 2

The method of example 1, wherein the user interface further comprises the standard deviation of the plurality of prices.

### Example 3

The method of example 1 or example 2, further comprising:

determining a severity of an anomaly based on the first price and the valid price range; and
wherein the causing of the presentation of the user interface is based on the severity of the anomaly.

### Example 4

The method of example 3, further comprising:

receiving, via a second user interface, a minimum severity; and
wherein the causing of the presentation of the user interface is further based on the minimum severity.

### Example 5

The method of any of examples 1 to 4, wherein:

the user interface comprises a first cost impact for the first item;
the user interface comprises a second cost impact for the second item; and
the first cost impact and the second cost impact are sorted in the user interface.

### Example 6

The method of any of examples 1 to 5, wherein:

the product is of a product type;
the product has a total price; and
the method further comprises:
determining, based on a plurality of products of the product type, a typical percentage of product cost for an item of the first item type;
determining, based on the first price and the total price, a percentage of product cost for the first item; and
based on the percentage of product cost for the first item and the typical percentage of product cost, the user interface comprises the percentage of product cost for the first item.

### Example 7

The method of any of examples 1 to 6, wherein the valid price range is further based on a trend of the plurality of prices for the first plurality of items of the first item type.

### Example 8

A system comprising:

a memory that stores instructions; and
one or more processors configured by the instructions to perform operations comprising:
receiving, from a client device and via a network, a first set of items for a product, the first set of items comprising a first item of a first item type and a second item of a second item type, the second item comprising a second set of component items;
accessing, from a database, first data for the first item, the first data comprising a first price;
accessing, from the database, a plurality of prices for a first plurality of items of the first item type;
determining, based on a standard deviation of the plurality of prices for the first plurality of items of the first item type, a valid price range;
accessing, from the database, data identifying a set of component items for each item of a second plurality of items of the second item type;
determining, based on the data, a typical set of component items;
determining a difference measure between the typical set of component items and the second set of component items; and
causing the client device to present a user interface comprising the first price and the difference measure.

### Example 9

The system of claim 8, wherein the user interface further comprises the standard deviation of the plurality of prices.

### Example 10

The system of example 8 or example 9, wherein the operations further comprise:

determining a severity of an anomaly based on the first price and the valid price range; and
wherein the causing of the presentation of the user interface is based on the sever of the anomaly.

### Example 11

The system of example 10, wherein the operations further comprise:

receiving, via a second user interface, a minimum severity; and
wherein the causing of the presentation of the user interface is further based on the minimum severity.

### Example 12

The system of any of examples 8 to 11, wherein:

the user interface comprises a first cost impact for the first item;
the user interface comprises a second cost impact for the second item; and
the first cost impact and the second cost impact are sorted in the user interface.

### Example 13

The system of any of examples 8 to 12, wherein:

the product is of a product type;
the product has a total price; and
the operations further comprise:
determining, based on a plurality of products of the product type, a typical percentage of product cost for an item of the first item type;
determining, based on the first price and the total price, a percentage of product cost for the first item; and
based on the percentage of product cost for the first item and the typical percentage of product cost, the user interface comprises the percentage of product cost for the first item.

### Example 14

The system of any of examples 8 to 13, wherein the valid price range is further based on a trend of the plurality of prices for the first plurality of items of the first item type.

### Example 15

A non-transitory computer-readable medium that stores instructions that, when executed by one or more processors, cause the one or more processors to perform operations comprising:

receiving, from a client device and via a network, a first set of items for a product, the first set of items comprising a first item of a first item type and a second item of a second item type, the second item comprising a second set of component items;
accessing, from a database, first data for the first item, the first data comprising a first price;
accessing, from the database, a plurality of prices for a first plurality of items of the first item type;
determining, based on a standard deviation of the plurality of prices for the first plurality of items of the first item type, a valid price range;
accessing, from the database, data identifying a set of component items for each item of a second plurality of items of the second item type;
determining, based on the data, a typical set of component items;
determining a difference measure between the typical set of component items and the second set of component items; and
causing the client device to present a user interface comprising the first price and the difference measure.

### Example 16

The computer-readable medium of example 15, wherein the user interface further comprises the standard deviation of the plurality of prices.

### Example 17

The computer-readable medium of example 15 or example 16, wherein the operations further comprise:

determining a severity of an anomaly based on the first price and the valid price range; and
wherein the causing of the presentation of the user interface is based on the severity of the anomaly.

### Example 18

The computer-readable medium of example 17, wherein the operations further comprise:

receiving, via a second user interface, a minimum severity; and
wherein the causing of the presentation of the user interface is further based on the minimum severity.

### Example 19

The computer-readable medium of any of examples 15 to 18, wherein:

the user interface comprises a first cost impact for the first item;
the user interface comprises a second cost impact for the second item; and
the first cost impact and the second cost impact are sorted in the user interface.

### Example 20

The computer-readable medium of any of examples 15 to 19, wherein:

the product is of a product type;
the product has a total price; and
the operations further comprise:
determining, based on a plurality of products of the product type, a typical percentage of product cost for an item of the first item type;
determining, based on the first price and the total price, a percentage of product cost for the first item; and

based on the percentage of product cost for the first item and the typical percentage of product cost, the user interface comprises the percentage of product cost for the first item.

FIG. 12 is a block diagram illustrating components of a machine 1200, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 12 shows a diagrammatic representation of the machine 1200 in the example form of a computer system within which instructions 1224 (e.g., software, a program, an application, an applet, an app, or other executable code) for causing the machine 1200 to perform any one or more of the methodologies discussed herein may be executed, in whole or in part. In alternative embodiments, the machine 1200 operates as a standalone device or may be connected (e.g., networked) to other machines. In a networked deployment, the machine 1200 may operate in the capacity of a server machine or a client machine in a server-client network environment, or as a peer machine in a distributed (e.g., peer-to-peer) network environment. The machine 1200 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1224, sequentially or otherwise, that specify actions to be taken by that machine. Further, while only a single machine is illustrated, the term “machine” shall also be taken to include a collection of machines that individually or jointly execute the instructions 1224 to perform all or part of any one or more of the methodologies discussed herein.

The machine 1200 includes a processor 1202 (e.g., a central processing unit (CPU), a graphics processing unit (GPU), a digital signal processor (DSP), an application-specific integrated circuit (ASIC), a radio-frequency integrated circuit (RFIC), or any suitable combination thereof), a main memory 1204, and a static memory 1206, which are configured to communicate with each other via a bus 1208. The machine 1200 may further include a graphics display 1210 (e.g., a plasma display panel (PDP), a light-emitting diode (LED) display, a liquid crystal display (LCD), a projector, or a cathode ray tube (CRT)). The machine 1200 may also include an alphanumeric input device 1212 (e.g., a keyboard), a cursor control device 1214 (e.g., a mouse, a touchpad, a trackball, a joystick, a motion sensor, or another pointing instrument), a storage unit 1216, a signal generation device 1218 (e.g., a speaker), and a network interface device 1220.

The storage unit 1216 includes a machine-readable medium 1222 on which are stored the instructions 1224 embodying any one or more of the methodologies or functions described herein. The instructions 1224 may also reside, completely or at least partially, within the main memory 1204, within the processor 1202 (e.g., within the processor's cache memory), or both, during execution thereof by the machine 1200. Accordingly, the main memory 1204 and the processor 1202 may be considered as machine-readable media. The instructions 1224 may be transmitted or received over a network 1226 via the network interface device 1220.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1222 is shown, in an example embodiment, to be a single medium, the term “machine-readable medium” should be taken to include a single medium or multiple media a centralized or distributed database, or associated caches and servers) able to store instructions. The term “machine-readable medium” shall also be taken to include any medium, or combination of multiple media, that is capable of storing instructions for execution by a machine (e.g., the machine 1200), such that the instructions, when executed by one or more processors of the machine (e.g., the processor 1202), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or componer Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application programming interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving, from a client device and via a network, a first set of items for a product, the first set of items comprising a first item of a first item type and a second item of a second item type, the second item comprising a second set of component items;
accessing, from a database, first data for the first item, the first data comprising a first price;
accessing, from the database, a plurality of prices for a first plurality of items of the first item type;
determining, by one or more hardware processors and based on a standard deviation of the plurality of prices for the first plurality of items of the first item type, a valid price range;
accessing, from the database, data identifying a set of component items for each item of a second plurality of items of the second item type;
determining, by the one or more hardware processors and based on the data, a typical set of component items;
determining, by the one or more hardware processors, a difference measure between the typical set of component items and the second set of component items; and
causing the client device to present a user interface comprising the first price and the difference measure.

2. The method of claim 1, wherein the user interface further comprises the standard deviation of the plurality of prices.

3. The method of claim 1, further comprising:
determining a severity of an anomaly based on the first price and the valid price range; and
wherein the causing of the presentation of the user interface is based on the severity of the anomaly.

4. The method of claim 3, further comprising:
receiving, via a second user interface, a minimum severity; and
wherein the causing of the presentation of the user interface is further based on the minimum severity.

5. The method of claim 1, wherein:
the user interface comprises a first cost impact for the first item;
the user interface comprises a second cost impact for the second item; and
the first cost impact and the second cost impact are sorted in the user interface.

6. The method of claim 1, wherein:
the product is of a product type;
the product has a total price; and
the method further comprises:
determining, based on a plurality of products of the product type, a typical percentage of product cost for an item of the first item type;
determining, based on the first price and the total price, a percentage of product cost for the first item; and
based on the percentage of product cost for the first item and the typical percentage of product cost, the user interface comprises the percentage of product cost for the first item.

7. The method of claim 1, wherein the valid price range is further based on a trend of the plurality of prices for the first plurality of items of the first item type.

8. A system comprising:
a memory that stores instructions; and
one or more processors configured by the instructions to perform operations comprising:
receiving, from a client device and via a network, a first set of items for a product, the first set of items comprising a first item of a first item type and a second item of a second item type, the second item comprising a second set of component items;
accessing, from a database, first data for the first item, the first data comprising a first price;
accessing, from the database, a plurality of prices for a first plurality of items of the first item type;
determining, based on a standard deviation of the plurality of prices for the first plurality of items of the first item type, a valid price range;
accessing, from the database, data identifying a set of component items for each item of a second plurality of items of the second item type;
determining, based on the data, a typical set of component items;
determining a difference measure between the typical set of component items and the second set of component items; and
causing the client device to present a user interface comprising the first price and the difference measure.

9. The system of claim 8, wherein the user interface further comprises the standard deviation of the plurality of prices.

10. The system of claim 8, wherein the operations further comprise:
determining a severity of an anomaly based on the first price and the valid price range; and
wherein the causing of the presentation of the user interface is based on the severity of the anomaly.

11. The system of claim 10, wherein the operations further comprise:
receiving, via a second user interface, a minimum severity; and
wherein the causing of the presentation of the user interface is further based on the minimum severity.

12. The system of claim 8, wherein:
the user interface comprises a first cost impact for the first item;
the user interface comprises a second cost impact for the second item; and
the first cost impact and the second cost impact are sorted in the user interface.

13. The system of claim 8, wherein:
the product is of a product type;
the product has a total price; and
the operations further comprise:
determining, based on a plurality of products of the product type, a typical percentage of product cost for an item of the first item type;
determining, based on the first price and the total price, a percentage of product cost for the first item; and
based on the percentage of product cost for the first item and the typical percentage of product cost, the user interface comprises the percentage of product cost for the first item.

14. The system of claim 8, wherein the valid price range is further based on a trend of the plurality of prices for the first plurality of items of the first item type.

15. A non-transitory computer-readable medium that stores instructions that, when executed by one or more processors, cause the one or more processors to perform operations comprising:
receiving, from a client device and via a network, a first set of items for a product, the first set of items comprising a first item of a first item type and a second item of a second item type, the second item comprising a second set of component items;
accessing, from a database, first data for the first item, the first data comprising a first price;
accessing, from the database, a plurality of prices for a first plurality of items of the first item type;
determining, based on a standard deviation of the plurality of prices for the first plurality of items of the first item type, a valid price range;
accessing, from the database, data identifying a set of component items for each item of a second plurality of items of the second item type;
determining, based on the data, a typical set of component items;
determining a difference measure between the typical set of component items and the second set of component items; and
causing the client device to present a user interface comprising the first price and the difference measure.

16. The computer-readable medium of claim 15, wherein the user interface further comprises the standard deviation of the plurality of prices.

17. The computer-readable medium of claim 15, wherein the operations further comprise:
determining a severity of an anomaly based on the first price and the valid price range; and
wherein the causing of the presentation of the user interface is based on the severity of the anomaly.

18. The computer-readable medium of claim 17, wherein the operations further comprise:
receiving, via a second user interface, a minimum severity; and
wherein the causing of the presentation of the user interface is further based on the minimum severity.

19. The computer-readable medium of claim 15, wherein:
the user interface comprises a first cost impact for the first item;
the user interface comprises a second cost impact for the second item; and
the first cost impact and the second cost impact are sorted in the user interface.

20. The computer-readable medium of claim 15, wherein:
the product is of a product type;
the product has a total price; and
the operations further comprise:
determining, based on a plurality of products of the product type, a typical percentage of product cost for an item of the first item type;
determining, based on the first price and the total price, a percentage of product cost for the first item; and
based on the percentage of product cost for the first item and the typical percentage of product cost, the user interface comprises the percentage of product cost for the first item.
